(19) United States
(12) Patent Application Publication
(10) Pub. No.: US 2014/0250914 A1
(43) Pub. Date: Sep. 11, 2014

(54) Starter Motor Shared Lubrication System

(71) Applicant: HAMILTON SUNDSTRAND CORPORATION, Windsor Locks, CT (US)

(72) Inventors: Matthew Slayter, Rockford, IL (US); Jeffrey M. Makulec, Rockford, IL (US); Jeffrey A. Stadler, Roscoe, IL (US)

(73) Assignee: Hamilton Sundstrand Corporation, Windsor Locks, CT (US)

(21) Appl. No.: 13/792,567

(22) Filed: Mar. 11, 2013

(51) Int. Cl. F02C 7/26

(52) U.S. Cl. CPC F02C 7/26
USPC 60/787

(57) ABSTRACT

A starter motor has a housing. The housing receives the starter motor and a plurality of locations to receive lubricant. The lubricant supply system shares a lubricant source with a main gas turbine engine to be started by the starter motor. The lubricant supply system has a shutoff valve. The shutoff valve is opened when starter motor is being driven to start a main gas turbine engine. The shutoff valve is generally closed once the main gas turbine engine is started.

### BACKGROUND OF THE INVENTION

This application relates to an air turbine starter for a gas turbine engine having a lubrication system which is shared with the gas turbine engine.

Aircraft include a plurality of gas turbine engines. As known, a gas turbine engine on an aircraft includes a fan delivering air into a compressor and into a bypass duct. The air is compressed in the compressor and delivered into a combustion section where it is mixed with fuel and ignited. Products of this combustion pass downstream over turbine rotors driving them to rotate.

The turbine rotors drive shafts which, in turn, drive the fan and compressor.

Typically it is necessary to begin rotation of the shafts and, hence, the compressor, fan and turbine rotors prior to start-up of the main gas turbine engines on an aircraft. Thus, starter motors are provided for starting the gas turbine engine. One such known starter is an air turbine starter.

Both the main gas turbine engine and the air turbine starter require lubrication. For a number of reasons, it is desirable to have a single lubricant system providing lubricating fluid to both the main gas turbine engine and the air turbine starter. The air turbine starter is typically only driven at start-up of the main gas turbine engine. Thus during most flight situations, there is no need for lubrication at most locations within the air turbine starter.

On the other hand, lubrication must be supplied to the gas turbine engine during its operation.

In the prior art, should there be a failure in the air turbine starter, it is possible that lubricant will be lost from the system, such that there is insufficient lubricant for the main gas turbine engine.

### SUMMARY OF THE INVENTION

A starter motor has a housing and a plurality of locations to receive lubricant. A lubricant supply system is shared with a main gas turbine engine to be started by the starter motor. The lubricant supply system has a shutoff valve. The shutoff valve is opened when the air turbine starter is being driven to start the main gas turbine engine. The shutoff valve is generally closed once the main gas turbine engine is started.

These and other features may be best understood from the following drawings and specification.

### BRIEF DESCRIPTION OF THE DRAWINGS

FIG. 1 shows an air turbine starter and main gas turbine engine.

FIG. 2A shows a first embodiment.

FIG. 2B shows the first embodiment in a second position.

FIG. 3A shows a second embodiment.

FIG. 3B shows the second embodiment in a second position.

FIG. 4A shows a third embodiment.

FIG. 4B shows the third embodiment in a second position.

### DETAILED DESCRIPTION

An aircraft 20 is shown schematically having a main gas turbine engine 22 with a shaft 24, and gas turbine engine components 26. As known, the components include a fan, a compressor, a combustor and a turbine. The turbine, compressor and fan all rotate with shaft 24 or, in some instances, also with a second shaft.

As shown schematically, an air turbine starter 40 is within a housing 41 and includes structure for receiving pressurized air, and driving a shaft 28. Shaft 28, in turn, drives the shaft 24 at start-up of the main gas turbine engine 22. The detail of the air turbine starter 40 may be as known and it is not illustrated in this Figure, other than schematically. A clutch body 30 connects the shaft 28 through a shaft 43 of the air turbine starter 40, shown schematically.

An oil pump 54 delivers lubricant through a line 52 into a flow restrictor 50 and into the housing 41. A lubricant level 32 is shown within the housing 41 and a transfer tube 44 extending through an internal wall 302 of the housing 41, which separates the housing into housing portions 300 and 301. Housing portion 300 receives clutch 30 and shaft 28, and portion 301 receives the air turbine starter 301.

In this embodiment, oil downstream of the transfer tube 44 passes through a line 48 and lubricates a number of locations 42, which may be bearings or seals associated with the air turbine starter 40. As shown, a shutoff valve 45 is supplied within the transfer tube 44, in a first embodiment. Oil is also delivered in some manner from the line 46 into a scupper 36, where it is supplied to output bearings 34 associated with the shaft 28.

As known, during startup of the main gas turbine engine 22 the air turbine starter 40 is driven to drive the shaft 28 to, in turn, rotate the shaft 24 and cause the engine 22 to start. Once the engine has started, the air turbine starter 40 is shut down. The clutch 30 will open. However, the shaft 28 is now driven by the shaft 24. Thus, the lubricant supplied to the bearings 34 is important at all times during operation.

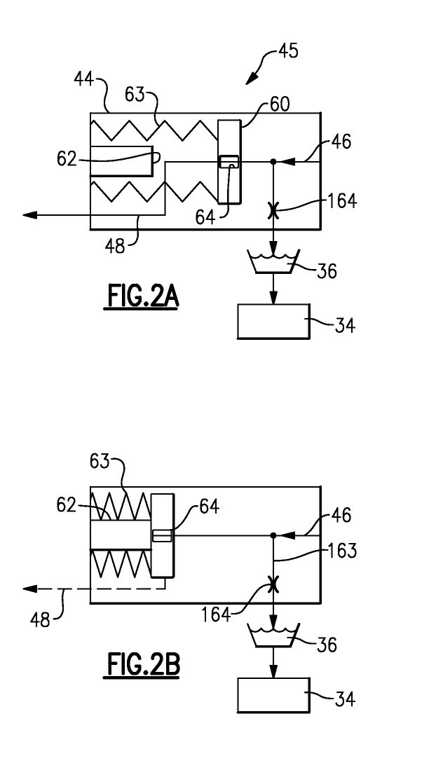

As shown in FIG. 2A, the shut off valve 45 may include a restriction 164 delivering oil into the scupper 36 and, hence, the bearings 34 at a location which is upstream from a valve element 60. The valve element 60 is biased by the force of the lubricant pressure in the supply line 46 against a spring force 63. As shown in the position of FIG. 2A, the spring force 63 has biased the valve element 60 away from a valve stop 62, such that lubricant can flow from the line 46 through the aperture 64 in valve element 60 and into the output line 48.

The shut off valve 45 is shown somewhat schematically and any known pressure actuated valve may be utilized.

As the main engine 22 increases its speed, the pressure of the lubricant on line 46 will also increase. At some point, the pressure on the line 46 will become sufficient to overcome the spring force 63, and the valve element will be driven against the valve stop 62, such that aperture 64 is blocked and significant lubricant is no longer delivered to the line 48.

Now, should the air turbine starter 40, fail as described above, the lubricant will not be lost from the system and the main gas turbine engine 22 will still have sufficient lubricant. Also, the bearing 34 will still be provided with lubricant, as the tap line 163 and restriction 164 are at a location upstream of the point where the valve element 60 will be closed.

While the lubricant leading to the output line 48 is shown to pass through the spring member providing the spring force 63, it will be understood to a worker of ordinary skill in the art, this is a schematic representation and the valve may deliver the lubricant to downstream locations in another manner.

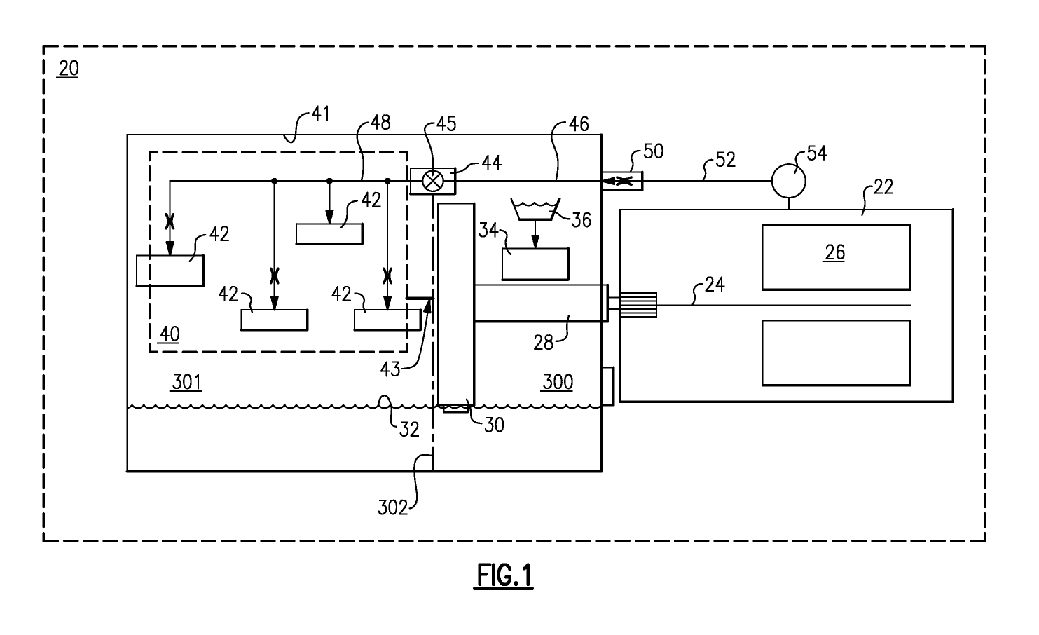

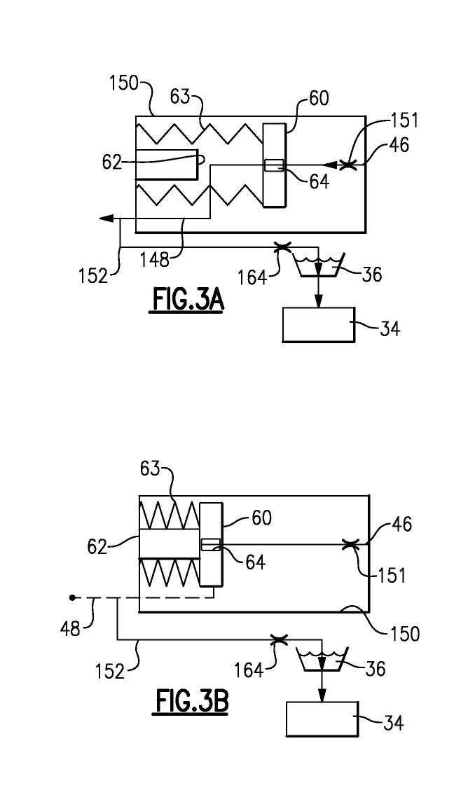

FIG. 3A shows another embodiment shut off valve 150. The shut off valve is shown schematically to include the stop 62, valve element 60, aperture 64, and the output line 148, which replaces the output line 48 of FIG. 1. There is a restriction 151 on the line 46 upstream of the valve 60. This embodiment 150 may replace the restrictor 50 of the FIG. 1 embodiment.

As shown in the position of FIG. 3A, the pressure on the line 46 is relatively low and the spring force 63 moves the valve 60 to the open position, such that lubricant may flow through the aperture 64.

As shown, a tap 152 from the output line 148 delivers the lubricant back through the restrictor 164 into the scuppers 36.

As shown in FIG. 3B, the main gas turbine engine 22 has now begun operation, such that the pressure on line 46 has become sufficient to overcome spring force 63. The aperture 64 is now closed. However, the valve 60/62 will still have some leakage. Thus, for purposes of this application, the shut-off valves could be said to be generally closed in this position. The leakage across the valve 60/62 will pass into the tap line 150, such that lubricant is still delivered to the scupper 36 during this time of operation.

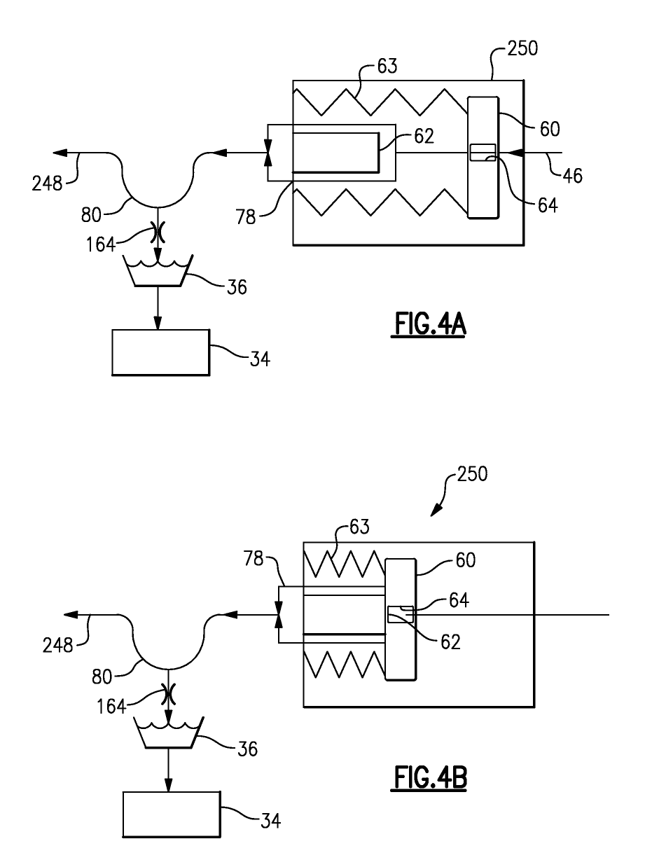

FIG. 4A shows yet another shut-off valve embodiment 250, again having a valve 62/64 and a spring bias 63. In the position shown in FIG. 4A, the lubricant can pass freely across the valve element 60, into output line 78, and eventually to a downstream output line 248. A U-pipe 80 is provided between the lines 78 into 48 to gather a leakage lubricant, and deliver it through the restriction 164 back to the scupper 36.

As shown in FIG. 4B, the shut-off valve 250 is now closed. However, there is leakage, and that leakage lubricant will accumulate in the bottom of the U-pipe 80, such that lubricant will be delivered to the scupper 36.

It should be understood the shut-off valve can be located anywhere along the line 46. The valve can be a separate component, or could be part of a subassembly, for example with the restrictor 50 of FIG. 1. While an air turbine starter is disclosed, other starter motors may benefit from these teachings.

Although an embodiment of this invention has been disclosed, a worker of ordinary skill in this art would recognize that certain modifications would come within the scope of this invention. For that reason, the following claims should be studied to determine the true scope and content of this invention.

1. A starter motor comprising:
a housing including a starter motor and a plurality of locations to receive lubricant;
a lubricant supply system for sharing a lubricant source with a main gas turbine engine to be started by said starter motor, and said lubricant supply system including a shutoff valve, said shutoff valve being opened when said starter motor is being driven to start a main gas turbine engine, and said shutoff valve being generally closed once the main gas turbine engine is started.

2. The starter motor as set forth in claim 1, wherein said starter motor is provided with a clutch between a clutch shaft which is to be connected to drive a shaft in the main gas turbine engine, and said clutch being positioned in one housing portion, and a drive portion of the starter motor being housed in a second housing portion, and there being a transfer tube extending a lubricant supply line between the first and second housing portions.

3. The starter motor as set forth in claim 2, wherein said shutoff valve being received within said transfer tube.

4. The starter motor as set forth in claim 2, wherein an oil scupper is provided to gather oil to be delivered to an output bearing for the clutch shaft.

5. The starter motor as set forth in claim 4, wherein a tap to deliver oil to said scupper is from a location upstream of said shutoff valve.

6. The starter motor as set forth in claim 4, wherein a tap for delivering oil to the scupper is downstream of the shutoff valve.

7. The starter motor as set forth in claim 6, wherein lubricant which has leaked across said shutoff valve, when said shutoff valve is in a closed position, is delivered into said scupper to lubricate said output bearing.

8. The starter motor as set forth in claim 7, wherein an output of said shutoff valve is communicated to a U-shaped pipe, such that there is a vertically lower most location that will capture leakage oil, and to assist in providing a sufficient quantity of leakage oil to said scupper.

9. The starter motor as set forth in claim 1, wherein said shutoff valve is located at an entrance to said housing.

10. The starter motor as set forth in claim 1, wherein said shutoff valve includes a spring biased valve member which is biased away from a valve stop, and wherein a pressure on the lubricant supply line opposes the spring force such that at higher pressure operation, the spring force is overcome and the valve moves towards a closed position.

11. The starter motor as set forth in claim 1, wherein said starter motor is an air turbine starter motor.

12. A gas turbine engine and starter motor combination comprising:
a gas turbine engine having a drive shaft to be driven by a starter motor, the starter motor including a housing, said housing including a plurality of locations to receive lubricant;
a lubricant supply system for sharing a lubricant source with the main gas turbine engine and said starter motor , and said lubricant supply system including a shutoff valve, said shutoff valve being opened when said starter motor is being driven to start a main gas turbine engine, and said shutoff valve being generally closed once the main gas turbine engine is started.

13. The combination as set forth in claim 12, wherein said starter motor is provided with a clutch between a shaft which is connected to drive the drive shaft in, and said clutch being positioned in one housing portion, and a drive portion of the starter motor being housed in a second housing portion, and a transfer tube extending a lubricant supply line between the first and second housing portions.

14. The combination as set forth in claim 13, wherein an oil scupper is provided to gather oil to be delivered to an output bearing for the clutch shaft.

15. The combination as set forth in claim 14, wherein a tap to deliver oil to said scupper is from a location upstream of said shutoff valve.

16. The combination as set forth in claim 14, wherein a tap for delivering oil to the scupper is downstream of the shutoff valve.

17. The combination as set forth in claim 16, wherein lubricant which has leaked across said shutoff valve, when said shutoff valve is in a closed position, is delivered into said scupper to lubricate said output bearings.

18. The combination as set forth in claim 17, wherein an output of said shutoff valve is communicated to a U-shaped pipe, such that it will capture leakage oil, and provide a sufficient quantity of leakage oil to said scupper.

19. The combination as set forth in claim 12, wherein said shutoff valve is located at an entrance to said housing.

20. The combination as set forth in claim 12, wherein said shutoff valve includes a spring biased valve element which is biased away from a valve stop, and wherein a pressure on the lubricant supply line opposes the spring force such that at higher pressure operation, the spring force is overcome and the valve moves towards a closed position.
